(19) United States
(12) Patent Application Publication
(10) Pub. No.: US 2025/0319390 A1
(43) Pub. Date: Oct. 16, 2025

(54) CUSTOMIZABLE GAME CONTROLLER

(71) Applicant: ACCO BRANDS CORPORATION, Lake Zurich, IL (US)

(72) Inventor: Jason A. Biheller, Lake Zurich, IL (US)

(73) Assignee: ACCO BRANDS CORPORATION, Lake Zurich, IL (US)

(21) Appl. No.: 18/633,784

(22) Filed: Apr. 12, 2024

(51) Int. Cl. A63F 13/24; A63F 13/23

(52) U.S. Cl. CPC A63F 13/24; A63F 13/23; A63F 2300/1043

(57) ABSTRACT

A customizable handheld game controller includes a body, at least one analog stick, at least two trigger buttons, at least one action button, at least one directional pad operatively installed to the body and a plurality of communication ports operatively mounted to the body and operatively connected to one or more processors. The communication ports are configured to receive communication connections of controller-input-generating devices. The processors are configured to program the communication ports to mirror a controller input. While a controller-input-generating device is connected to a communication port, when the device is triggered, it inputs the programmed controller input. The communication ports can be magnetic such that a magnetic button can be attached, or they can be female jacks such that a male plug can be plugged in, or any other means of mechanical/electrical connection.

### FIELD OF INVENTION

The present invention relates to video games, in particular to customizing handheld controllers for playing video games.

### BACKGROUND

Conventional video game controllers for use with game consoles, mobile devices, and computers are designed with ergonomics in mind. However, not all hands are similar. Some third-party controllers on the market add additional paddle buttons that allow a user to map buttons to the paddle buttons to reach them easier. For example, remapping the jump button to a paddle button can allow a user to jump and aim without needing to take their finger off a thumb stick. However, even these buttons may not be comfortable to reach for every hand.

The Xbox Adaptive Controller allows a user to plug in custom devices into the 3.5 mm jacks, where each jack corresponds to a single button input. The devices can be placed far away from the controller, i.e., the floor, to allow the user to use their feet to input button presses. The controller is mainly targeted at gamers with disabilities, preventing them from using a normal gaming controller. As such, able-bodied gamers are less likely to be aware of the benefits of being buttons not needing to be physically on the controller.

### SUMMARY OF THE INVENTION

The present disclosure relates to customizable game controller. In accordance with an embodiment, the controller includes a body. At least one analog stick, at least two trigger buttons, at least one action button, and at least one directional pad are operatively installed to the body. Furthermore, one or more processors disposed in the body operatively connected to the at least one analog stick, the at least two trigger buttons, the at least one action button, and the at least one directional pad to receive user input via the at least one analog stick, the at least two trigger buttons. Furthermore, one or more processors are disposed in the body operatively connected to the at least one analog stick, the at least two trigger buttons, the at least one action button, and the at least one directional pad to receive user input via the at least one analog stick, the at least two trigger buttons. The body also includes a plurality of communication ports operatively mounted to the body and operatively connected to the one or more processors. The plurality of communication ports are configured to receive communication connections of controller-input-generating devices. The one or more processors are configured to program one or more of the plurality of communication ports to mirror a controller input.

In one embodiment, the plurality of communication ports include magnets. The magnetic communication ports are configured to magnetically couple with the communication connection of the controller-input-generating device.

In one embodiment, the plurality of communication ports include female ports and the communication connections are male plugs. The female communication ports are configured to receive the male plugs.

In one embodiment, the plurality of communication ports include ports disposed on a back of the body.

In one embodiment, the plurality of communication ports include ports disposed on a side of the body.

In one embodiment, the plurality of communication ports include ports disposed on a top of the body

In one embodiment, the plurality of communication ports include at least three communication ports.

In one embodiment, the game controller includes a combination with a controller generating input device coupled to one of the connection ports.

The accompanying drawings, which are incorporated in and constitute a part of the specification, illustrate various example systems, methods, and so on, that illustrate various example embodiments of aspects of the invention. It will be appreciated that the illustrated element boundaries (e.g., boxes, groups of boxes, or other shapes) in the figures represent one example of the boundaries. One of ordinary skill in the art will appreciate that one element may be designed as multiple elements or that multiple elements may be designed as one element. An element shown as an internal component of another element may be implemented as an external component and vice versa. Furthermore, elements may not be drawn to scale.

### BRIEF DESCRIPTION OF THE DRAWINGS

FIG. 1 illustrates a front view of an example customizable game controller.

FIG. 2 illustrates a back view of an example customizable game controller.

FIG. 3 illustrates an example customizable game controller wherein the communication ports are female jacks to receive male plugs.

FIG. 4 illustrates examples of devices that can be connected to the female connection ports.

FIG. 5 illustrates a trigger button connecting to the female connection port via a 3.5 mm jack.

FIG. 6 illustrates a block diagram of an example customizable handheld game controller.

FIG. 7 illustrates a flow diagram for programming the communication ports.

FIG. 8 illustrates a flow diagram for an example method for customizing a handheld game controller.

### DETAILED DESCRIPTION

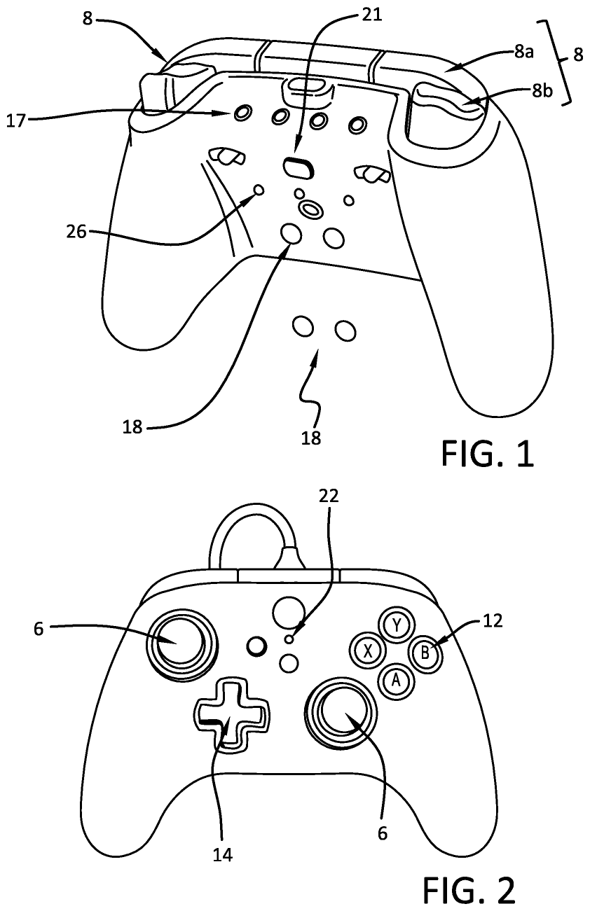

FIG. 1 illustrates the back side of an example customizable handheld game controller 2 and FIG. 2 illustrates the front side of the example customizable handheld game controller 2. The handheld game controller 2 includes a body 4. Operatively installed to the body 4 may be at least one analog stick 6, at least two trigger buttons 8 (which may include shoulder trigger inputs 8a and lower trigger inputs 8b), at least one action button 12, and at least one directional pad 14. The analog stick 6, trigger buttons 10, action button 12, and directional pad 14 of the game controller 2 may serve as a first control interface between the controller's user and a desired video game. In the embodiments depicted in the example game controller 2 in FIGS. 1-4, the control interface of the game controller 2 includes two analog sticks 6, two trigger buttons 10, a plurality of action buttons 12, and one directional pad 14.

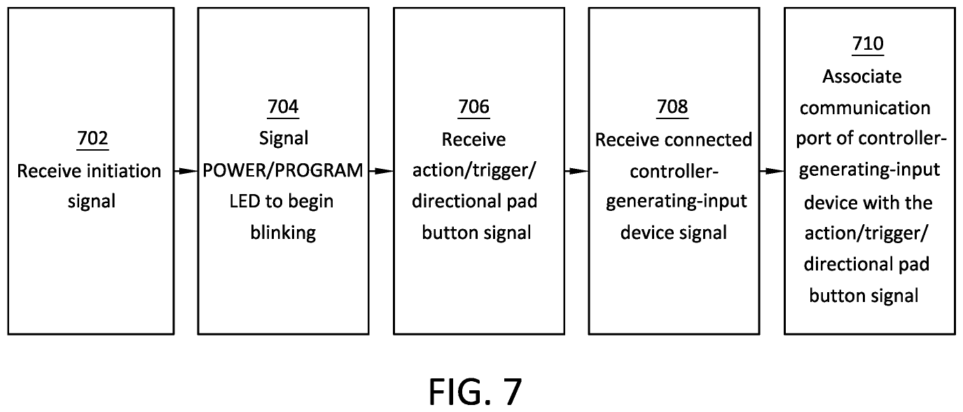

The customizable handheld game controller 2 may also include a plurality of communication ports 16 operatively mounted to the body 4. The plurality of communication ports 16 are configured to receive communication connections 18 of controller-input-generating devices 20. The plurality of communication ports 16 may be operatively connected to a processor 602 (shown in FIG. 7). The processor 602 can allow a user to program one or more of the communication ports 16 to mirror a controller input. The processor 602 starts the programming process after the user holds down the program button 21. After three seconds, the power/program light emitting diode (LED) 22 will begin flashing, indicating that the processor is ready to program the communication port. A controller input can be any of the any of the signals sent from to the processor 602 when an action button 12 is pressed, a trigger button 8 is pressed, directional pad 14 is pressed, or analog stick 6 is moved. Thus, the handheld game controller 2 advantageously allows users to place buttons where they see fit, whether it is on the controller or simply connected to the controller and placed elsewhere.

In another embodiment, the communication ports 16 may be female connection ports 17 such that they are configured to receive male plugs 19 from the communication connections 18 of the controller-input-generating device 20. The female connection ports 17 may be 3.5 mm jacks configured to connect to 3.5 mm plugs. The female connection ports 17 may be located on top side of the body 4 of the controller 2. There may be at least three female connection ports 17.

In another embodiment, the communication ports 16 may be magnetic communication ports 26 which are magnetic such that the ports magnetically couple with a communication connection 18 of a controller-input-generating device 20. The magnetic communication ports 26 may be disposed on the top, sides or back of the body 4 of the controller 2. There may be at least three magnetic communication ports 26.

In another embodiment, the handheld game controller 2 may be in combination with a controller-input-generating device 20 that is coupled to one of the magnetic connection ports 26 of the game controller. The combination may include, but is not limited to, the game controller 2 with the analog stick 6, a game controller 2 with the trigger button 8, or a game controller 2 with the action button 12. The handheld controller 2 may also be a combination with a non-controller-input-generating device, such as a light emitting diode (LED) 30.

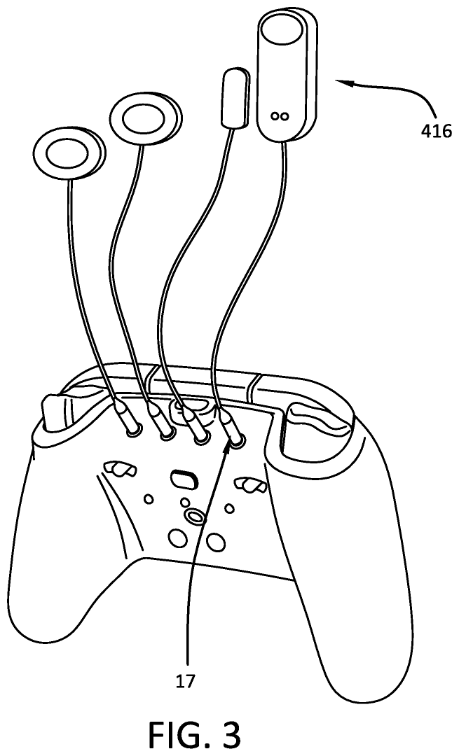

FIG. 3 illustrates an example embodiment of a customizable handheld game controller 2 (FIG. 1) where multiple controller-input-generating devices 20 (FIG. 1) are connected to the female connection ports 17 (FIG. 1). The controller-input-generating devices 20 are connected via a wired connection, which can allow the devices to be wherever the user wants.

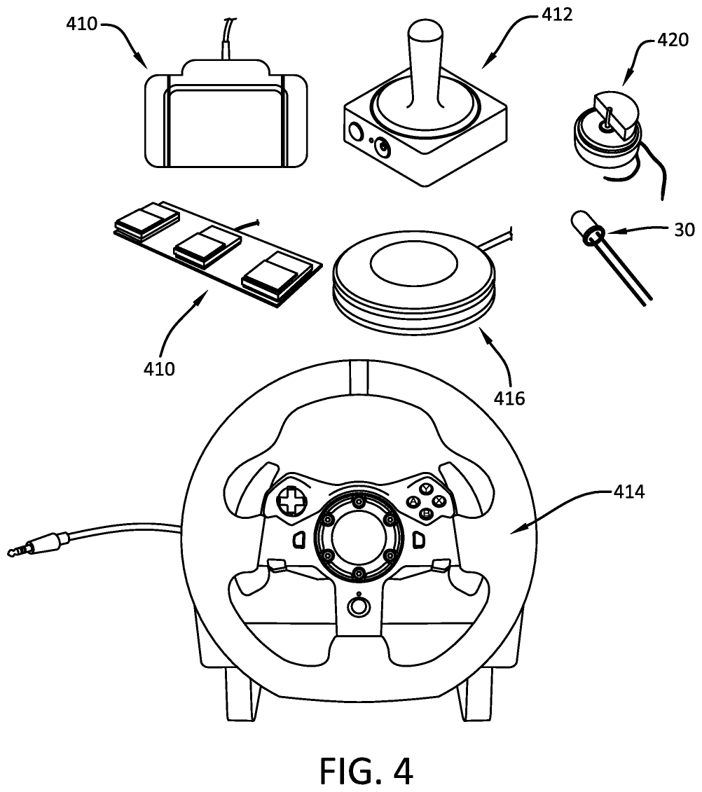

FIG. 4 illustrates an example of the types of devices that can be connected to the female connection ports 17 (FIG. 1). Such examples include, but are not limited to, a foot pedal 410, a joystick 412, a steering wheel 414, and an action button 416. The foot pedal 410 can be any button where the cable is long enough to reach the floor, such that the user can step on it to activate the button. The joystick 412 is a hand-held input device used primarily for controlling the movement of objects on a screen. It consists of a stick-like lever that pivots on a base and is typically mounted on a platform or held in the hand. The steering wheel 414 device simulates the experience of driving a vehicle. It mimics the form and function of a real-world steering wheel. The action button is any standardized button that does not have a specific function, i.e., using as a foot pedal. The controller-input-generating devices 20 may also include LEDs 30. The wired connection allows the user to place a controller-input-generating device 20 (FIG. 1) on the ground and activate the controller input by using their feet.

In another embodiment, the handheld game controller 2 (FIG. 1) may be in combination with a controller-input-generating device 20 (FIG. 1) that is coupled to one of the female connection ports 17 (FIG. 1) of the game controller 2. The combination may include, but is not limited to, the game controller 2 with a foot pedal 410, the game controller 2 with a joystick 412, a game controller 2 with a steering wheel 414, a game controller 2 with a trigger button 422, or a game controller 2 with an action button 416. The combination may handheld game controller 2 may also be in combination with devices that do not generate inputs, and merely enhance the user experience. Examples of this include a rumble module 420 or an LED 30. A user may want a rumble module 420 to be placed such that a specific area rumbles harder than the rest of the controller, or may just want to feel the vibrations in a different location. A user may wish to place an LED 30 in a location to brighten up a control or to make the controller 2 more interesting to look at.

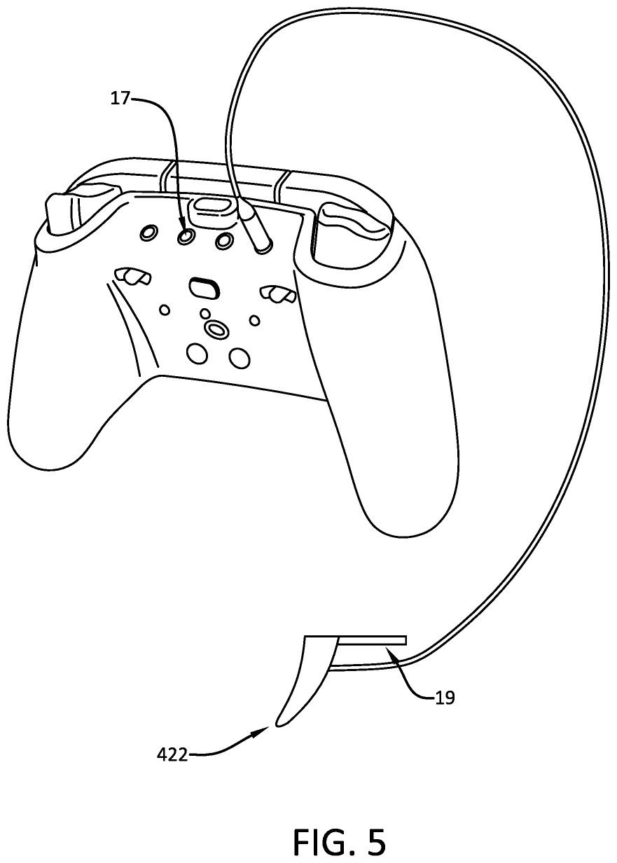

FIG. 5 illustrates an example embodiment where an additional trigger button 422 is connected to the female connection port 17 (FIG. 1). The trigger 422 itself contains the male plug 19, such that the trigger 422 can plug directly into the female connection port 17, giving the user the ability to place an additional trigger button 422 on the top of the body 4 (FIG. 1) of the controller.

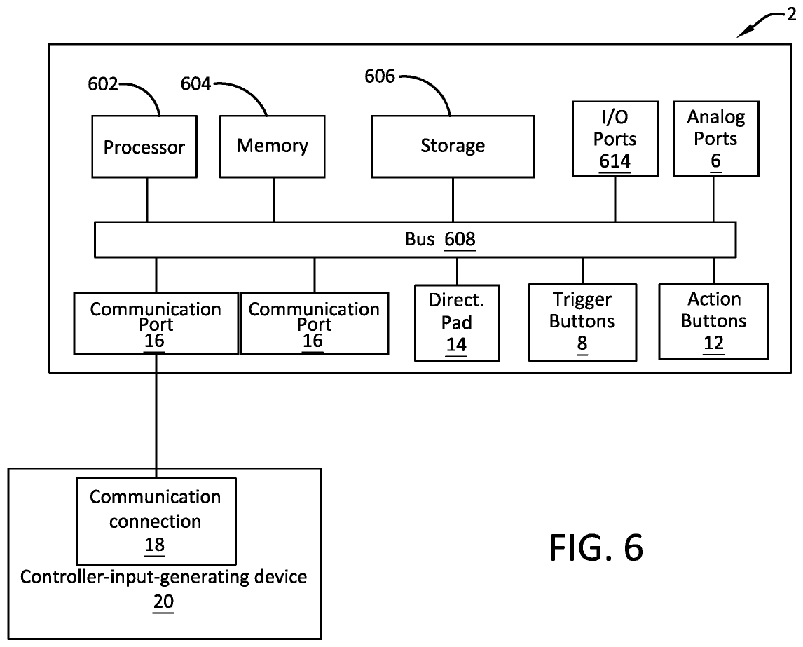

FIG. 6 illustrates a block diagram of an example customizable handheld game controller 2 (FIG. 1). The controller includes a processor 602, a memory 604, a plurality of communication ports 16 (FIG. 1), and a storage 606 operably connected by a bus 608.

In one example, the handheld game controller 2 (FIG. 1) may transmit input and output signals as described above via, for example, communication ports 16 (FIG. 1). The handheld game controller 2 may also communicate with a gaming device via I/O Ports 614. The handheld game controller 2 may receive user input via the analog stick 6 (FIG. 1), trigger buttons 8 (FIG. 1), action buttons 12 (FIG. 1), directional pad 14 (FIG. 1), etc. and transmit user input signals to the gaming device via the I/O Ports 614. The processor 602 may communicate with the connection ports 16 allowing the user to program the connection ports 16 to mirror a controller input. In some embodiments, the processor 602 can program each connection port 16 to mirror more than one controller input, i.e., when a steering wheel 414 is connected to a connection port 16.

The processor 602 can be a variety of various processors including dual microprocessor and other multi-processor architectures. The memory 604 can include volatile memory or non-volatile memory. The non-volatile memory can include, but is not limited to, ROM, PROM, EPROM, EEPROM, and the like. Volatile memory can include, for example, RAM, synchronous RAM (SRAM), dynamic RAM (DRAM), synchronous DRAM (SDRAM), double data rate SDRAM (DDR SDRAM), and direct RAM bus RAM (DRRAM). The storage 606 may be operably connected to the processor 602 via the bus 608. The storage 606 can include, but is not limited to, devices like a magnetic disk drive, a solid-state disk drive, a flash memory card, or a memory stick. The memory 604 can store processes or data. The storage 606 or memory 604 can store an operating system that controls and allocates resources of the handheld game controller 2 (FIG. 1).

The bus 608 can be a single internal bus interconnect architecture or other bus or mesh architectures. While a single bus is illustrated, it is to be appreciated that handheld game controller 2 (FIG. 1) may communicate with various devices, logics, and peripherals using other buses that are not illustrated (e.g., PCIE, SATA, Infiniband, 1394, USB, Ethernet). The bus 608 can be of a variety of types including, but not limited to, a memory bus or memory controller, a peripheral bus or external bus, a crossbar switch, or a local bus. The local bus can be of varieties including, but not limited to, an industrial standard architecture (ISA) bus, a microchannel architecture (MCA) bus, an extended ISA (EISA) bus, a peripheral component interconnect (PCI) bus, a universal serial (USB) bus, and a small computer systems interface (SCSI) bus.

The handheld game controller 2 (FIG. 1) may interact with input/output devices via I/O Ports 614. Input/output devices can include, but are not limited to, a keyboard, a microphone, a pointing and selection device, cameras, video cards, displays, gaming devices, and the like. The I/O Ports 614 can include but are not limited to, serial ports, parallel ports, and USB ports. The handheld game controller 2 can operate in a network environment and thus may be connected to network devices via the I/O Ports 614. Through the I/O Ports 614, the handheld game controller 2 may interact with a network. Through the network, the handheld game controller 2 may be logically connected to remote devices. The networks with which the handheld game controller 2 may interact include, but are not limited to, a local area network (LAN), a wide area network (WAN), and other networks. The I/O Ports 614 can connect to LAN technologies including, but not limited to, fiber distributed data interface (FDDI), copper distributed data interface (CDDI), Ethernet (IEEE 802.3), token ring (IEEE 802.5), wireless computer communication (IEEE 802.11), Bluetooth (IEEE 802.15.1), Zigbee (IEEE 802.15.4) and the like. Similarly, the I/O Ports 614 can connect to WAN technologies including, but not limited to, point to point links, circuit switching networks like integrated services digital networks (ISDN), packet switching networks, and digital subscriber lines (DSL). While individual network types are described, it is to be appreciated that communications via, over, or through a network may include combinations and mixtures of communications.

FIG. 7 illustrates a flow diagram for programming the game controller 2 (FIG. 1). In step 702, the processor receives an initiation signal after the program button 21 is held down for three seconds. In step 704, the processor signals the power/program LED 22 to begin blinking, indicating that the controller is ready to record inputs. In step 706, the processor receives a signal of whichever action button, trigger button, or directional pad is pressed that a user wants to be mirrored. In step 708, the processor receives a controller-input-generating device signal from a controller-input-generating device 20 (FIG. 1) that the user intended to program the button to. In step 710, the processor associates the communication port 16 connected to the activated controller-input-generating device with the action, trigger, or directional pad button that was pressed.

This process is repeated for each connected controller-input-generating device that is intended to be programmed. The button assignments will remain in memory even after disconnected.

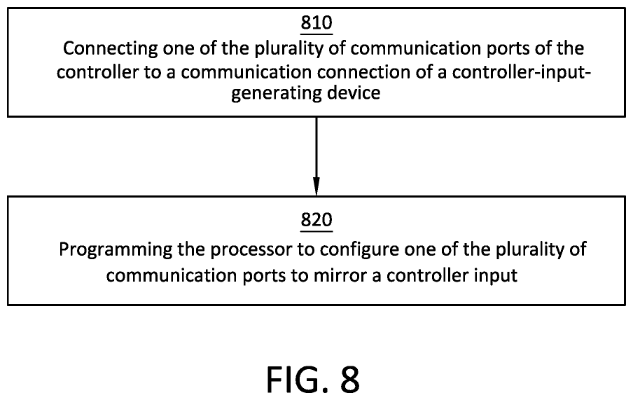

Example methods may be better appreciated with reference to the flow diagram of FIG. 8. While for purposes of simplicity of explanation, the illustrated methodologies are shown and described as a series of blocks, it is to be appreciated that the methodologies are not limited by the order of the blocks, as some blocks can occur in different orders or concurrently with other blocks from that shown and described. Moreover, less than all the illustrated blocks may be required to implement an example methodology. Furthermore, additional methodologies, alternative methodologies, or both can employ additional blocks, not illustrated.

In the flow diagrams, blocks denote “processing blocks” that may be implemented with logic. The processing blocks may represent a method step or an apparatus element for performing the method step. The flow diagrams do not depict syntax for any particular programming language, methodology, or style (e.g., procedural, object-oriented). Rather, the flow diagrams illustrate functional information one skilled in the art may employ to develop logic to perform the illustrated processing. It will be appreciated that in some examples, program elements like temporary variables, routine loops, and so on, are not shown. It will be further appreciated that electronic and software applications may involve dynamic and flexible processes so that the illustrated blocks can be performed in other sequences that are different from those shown or that blocks may be combined or separated into multiple components. It will be appreciated that the processes may be implemented using various programming approaches like machine language, procedural, object oriented or artificial intelligence techniques.

FIG. 8 illustrates a flow diagram for an example method 800 for customizing a handheld game controller 2 (FIG. 1). In 810, the method includes connecting one of the plurality of communication ports 16 (FIG. 1) of the controller to a communication connection 18 of a controller-input-generating device. In 820, the method includes programming the processor to configure one of the plurality of communication ports 16 to mirror a controller input. In another embodiment, the processor can be configured to program more than one controller input.

What is claimed is:

1. A customizable handheld game controller, said game controller comprising:
a body;
at least one analog stick, at least two trigger buttons, at least one action button, and at least one directional pad operatively installed to the body;
one or more processors disposed in the body operatively connected to the at least one analog stick, the at least two trigger buttons, the at least one action button, and the at least one directional pad to receive user input via the at least one analog stick, the at least two trigger buttons; and
a plurality of communication ports operatively mounted to the body and operatively connected to the one or more processors;
wherein the plurality of communication ports are configured to receive communication connections of controller-input-generating devices; and
wherein the one or more processors are configured to program one or more of the plurality of communication ports to mirror a controller input.

2. The customizable handheld game controller of claim 1,
wherein the plurality of communication ports include magnets; and
wherein the plurality of communication ports are configured to magnetically couple with the communication connection of the controller-input-generating device.

3. The customizable handheld game controller of claim 2, wherein the plurality of communication ports include ports disposed on a back of the body.

4. The customizable handheld game controller of claim 2, wherein the plurality of communication ports include ports disposed on a side of the body.

5. The customizable handheld game controller of claim 2, wherein the plurality of communication ports include ports disposed on a top of the body.

6. The customizable handheld game controller of claim 2, wherein the plurality of communication ports include at least three communication ports.

7. The customizable handheld game controller of claim 2, in combination with a controller generating input device coupled to one of the connection ports.

8. The customizable handheld game controller of claim 7, wherein the controller-input-generating device includes a trigger button.

9. The customizable handheld game controller of claim 7, wherein the controller-input-generating device includes an action button.

10. The customizable handheld game controller of claim 7, wherein the controller-input-generating device includes a analog stick.

11. The customizable handheld game controller of claim 1,
wherein the plurality of communication ports include female ports;
wherein the communication connections are male plugs; and
wherein the female communication ports are configured to receive the male plugs.

12. The customizable handheld game controller of claim 11,
wherein the female connection ports are 3.5 mm jacks; and
wherein the male communication ports are 3.5 mm plugs.

13. The customizable handheld game controller of claim 11, wherein the plurality of communication ports include at least three communication ports.

14. The customizable handheld game controller of claim 11, wherein the plurality of communication ports include ports located on a top of the controller.

15. The customizable handheld game controller of claim 11, in combination with a controller generating input device coupled to one of the connection ports.

16. The customizable handheld game controller of claim 11, in combination with a rumble module coupled to one of the connection ports.

17. The customizable handheld game controller of claim 11, in combination with a light emitting diode (LED) coupled to one of the connection ports.

18. The customizable handheld game controller of claim 15, wherein the controller-input-generating device includes a foot pedal.

19. The customizable handheld game controller of claim 15, wherein the controller-input-generating device includes a joystick.

20. The customizable handheld game controller of claim 15, wherein the controller-input-generating device includes a steering wheel.

21. The customizable handheld game controller of claim 15, wherein the controller-input-generating device includes an action button.

22. The customizable handheld game controller of claim 15, wherein the controller-input-generating device includes a trigger button.

23. The customizable handheld game controller of claim 1, wherein the one or more processors are configured to program one or more of the plurality of communication ports to mirror more than one controller input.

24. A method of customizing a handheld game controller, the method comprising:
connecting one of a plurality of communication ports of the controller to a communication connection of a controller-input-generating device; and
programming the processor to configure one of the plurality of communication ports to mirror a controller input.
